(19) United States
(12) Patent Application Publication
(10) Pub. No.: US 2009/0123628 A1
(43) Pub. Date: May 14, 2009

(54) LOW ACYL GELLAN GELS WITH REDUCED THERMAL HYSTERESIS AND SYNERESIS

(76) Inventors: Shinya Ikeda, San Diego, CA (US); Todd A. Talashek, San Diego, CA (US)

Correspondence Address: Jane Shershenovich;CP Keleo U.S., Inc., Suite 1000, 1000 Parkwood Circle, Atlanta, GA, 30339, US

(21) Appl. No.: 11/937,936

(22) Filed: Nov. 9, 2007

(51) Int. Cl. A23L 1/054

(52) U.S. Cl. 426/573

(57) ABSTRACT

The present invention provides a composition of matter where gelatin-like gels with little thermal hysteresis and syneresis are prepared from water, low acyl gellan gum, and tamarind seed xyloglucan. The composition may further include salts up to an amount equivalent to the ionic strength of 30 mM. The gel exhibits a thermal hysteresis as defined as the difference between gel setting and melting temperatures typically less than about 5° C. and no appreciable syneresis. Methods for preparing gels having storage modulus values in the order of 100 Pa and 1,000 Pa and melting temperatures of about 30° C. and 40° C., respectively, are also disclosed.

### FIELD OF THE INVENTION

Polysaccharide-based gelling products are often preferred over animal-derived gelatin for a number of reasons. According the present invention a form of gellan gum is described that can be used as an alternative to gelatin in various applications, especially certain food applications.

### BACKGROUND OF THE INVENTION

Gellan gum is a capsular polysaccharide produced by the bacterium Sphingomonas elodea. Gellan gum is manufactured by fermenting an appropriate strain of Sphingomonas with a readily available carbohydrate source. The constituent sugars of gellan gum are glucose, glucuronic acid and rhamnose in the molar ratio of 2:1:1. These are linked together to give a primary structure comprising a linear tetrasaccharide repeat unit (O'Neill M. A. et al., Carbohydrate Research, Vol. 124, p. 123, 1983; Jansson, P. E. et al., Carbohydrate Research, Vol. 124, p. 135, 1983). X-ray diffraction analysis shows that gellan gum adopts a three-fold, left-handed, parallel, and double-stranded helical conformation at temperatures below the transition temperature (Chandrasekaran, R. et al., Carbohydrate Research, Vol. 175, pp. 1-15, 1988; Chandrasekaran, R. et al., Carbohydrate Research, Vol. 181, pp. 23-40, 1988). In the native or high acyl (HA) form, two acyl substituents, acetate and glycerate, are present. Both substituents are located on the same glucose residue and, on average, there is one glycerate per repeat unit and one acetate per every two repeat units. In the low acyl (LA) form, the acyl groups have been removed to produce a linear repeat unit substantially lacking such groups. Deacylation of the gum is usually carried out by treating a fermentation broth with alkali.

The HA form of gellan gum does not require addition of any substances for gel formation provided the gum concentration is higher than the critical concentration. HA gellan gum produces a soft, elastic, and non-brittle gel when its solution is cooled below the setting temperature. HA gellan gum gels will soften with heat and melt at a temperature proximate to the setting temperature.

The LA form of gellan gum generally requires a gelation agent such as salt or acid for gel formation. For example, LA gellan gum forms a firm, non-elastic, and brittle gel when cooled in the presence of gel-promoting cations, preferably divalent cations, such as calcium and magnesium. LA gellan gum gels show remarkable thermal hysteresis between the setting and melting temperatures. As the concentration of added ions increases, the melting temperature increases. Because the setting temperature of LA gellan gum is less sensitive to the ion concentration, thermal hysteresis is progressively widened with increasing ion concentration.

The requirement of a gelation agent to gel LA gellan gum can present problems for certain applications. The general mechanism of gelation for LA gellan gum is that a gelation agent, such as salt or acid, screens electrostatic repulsions between gellan gum molecules and promotes lateral association between gellan gum molecules in the double-stranded helical conformation. Associated parts not only play a role as cross-linking domains in a percolated gel network but also contribute to a dramatic increase in the melting temperature because they are more thermally stable in comparison with unassociated molecules. The high melting temperature limits the use of LA gellan gum in a number of applications, such as soft capsules where gelatin is predominantly used. The high melting temperature also limits the use of LA gellan gum in food applications where a gel is intended to melt in the mouth at body temperature to create preferred mouth-feel and flavor release.

The gel network of LA gellan gum becomes coarser as more LA gellan gum molecules in the double-stranded helical conformation associate. LA gellan gels thus tend to progressively release internal liquid with increasing interhelical association. The separation of liquid from a gel upon gel formation is referred to as syneresis. Syneresis should be avoided in most applications since it is generally perceived as deterioration in product quality. Applications which prefer the use of LA gellan gum are frequently limited due to syneresis.

There is a need in the industry to provide the gels produced using LA gellan gum but with reduced thermal hysteresis and syneresis. Moreover, polysaccharides are preferred over gelatin in many applications, however, gellan alternatives have been limited for the reasons set forth.

### BRIEF SUMMARY OF THE INVENTION

One invention described herein is a composition of a gel comprising LA gellan gum as the gelling component and xyloglucan as the gelation agent wherein little thermal hysteresis and syneresis are exhibited. The gel contains a binary polysaccharide blend of about 0.05%-1.5%, more preferably about 0.2%-1.2%, most preferably about 0.3%-1.0% gellan gum and about 0.25%-2.5%, more preferably about 0.4-1.5%), most preferably about 0.5%-1.0% xyloglucan. A fairly strong gel with a storage modulus value of at least about ca. 2,500 Pa is formed by blending about 1.0% LA gellan gum and about 1.5% xyloglucan, while the melt temperature remains lower than about 40° C. and thermal hysteresis is less than 10° C. This thermo-reversible gelling system has potential as a gelatin alternative in non-food applications, including soft capsules. Stronger gels can be obtained at higher gum levels, while the melt temperature also increases, leading to wider thermal hysteresis. For example, a gel comprising 1.5% gellan gum and 2.25% xyloglucan shows a very large storage modulus value around 8,500 Pa but the melting temperature and thermal hysteresis become about 67° C. and over 30° C., respectively.

The systems described herein have the ability to replace gelatin in food applications where a gel preferably melts in the mouth at body temperature. The storage modulus value of resulting gels can reach >350 Pa, while the melting temperature remains around 30° C. Based on microscopic and theological studies, the underlying mechanism of this novel route of gelation of gellan gum has been attributed to volume exclusion effects of xyloglucan that occupies large hydrodynamic volume but does not form a gel by itself. To support this view, polysaccharides that tend to self-associate (e.g., xanthan gum, galactomannans) or ionic polysaccharides (e.g. xanthan gum, CMC) have failed to induce gelation of gellan gum in the absence of additional salt.

### BRIEF DESCRIPTION OF THE SEVERAL VIEWS OF THE DRAWINGS

The foregoing summary will be better understood when read in conjunction with the Detailed Description of the Invention and FIGS. 1-5.

FIG. 1 shows synergistic interactions between LA gellan gum and xyloglucan providing a low level of hysteresis.

FIG. 2 shows a pair of graphical representations FIGS. 2a and 2b illustrating effects of the ionic strength on interactions between LA gellan gum and xyloglucan on storage moduli, selling and melting temperatures.

FIG. 3 shows effects of the mixing ratio of LA gellan gum and xyloglucan on setting and melting temperatures.

FIG. 4 demonstrates synergistic interactions between LA gellan gum and xyloglucan at temperatures both below and above the conformational transition temperature.

FIG. 5 shows a series of graphical representations FIGS. 5a, 5b, and 5c illustrating gel setting/melting profiles of LA gellan gum/xyloglucan blend gels that are beneficial in soft capsule application.

### DETAILED DESCRIPTION OF THE INVENTION

The invention provides a composition wherein xyloglucan is used as a novel gelation agent for LA gellan gum which enables the preparation of gels that mimic the setting/melting behavior of gelatin gels.

LA gellan gum exhibits little synergy with other polysaccharides, while several other pairs of polysaccharides are known for their synergistic interactions. In particular, synergistic interactions between xanthan and galactomannans and those between κ-carrageenan and galactomannans or konjac glucomannan have already been utilized in the food industry.

Various molecular mechanisms can be invoked to explain synergistic interactions in binary polysaccharide systems. In the case of the pair of xanthan and galactomannan, intermolecular binding between xanthan and galactomannan has been probed in X-ray fiber diffraction patterns from their mixed systems and attributed to binding between the disordered backbone of xanthan and galactomannan. This model, while not intended to be limiting, is at least one plausible theory considering the steric compatibility between the glucan and mannan backbones. (Chandrasekaran, R. et al., Carbohydrate Polymers, Vol. 32, pp. 201-208, 1997)

For the pair of κ-carrageenan and galactomannan or glucomannan, no direct evidence for intermolecular binding has been reported. Experimental results based on differential scanning calorimetry (DSC) and electron spin resonance (ESR) suggest that galactomannan or glucomannan chains are attached to the surface of local aggregates or microcrystalline regions of κ-carrageenan and link these locally aggregated/crystallized regions to form a network (Williams, P. A. et al., Macromolecules, Vol. 26, pp. 5441-5446, 1993).

Emerging evidence for synergistic interactions between LA gellan gum and xyloglucan (e.g., Ikeda, S. et al. Food Hydrocolloids, Vol. 18, pp. 669-675, 2004) has inspired the idea of using LA gellan gum/xyloglucan blends as a novel gel system that exhibits reduced thermal hysteresis and syneresis. Xyloglucan is a structural polysaccharide that occurs widely in the primary cell wall of higher plants. The major source of commercially available food-grade xyloglucan is the seed of tamarind tree (Tamarindus indica) that grows world-wide in the tropical region. Xyloglucan has a backbone of 1→4 linked β-D-glucose, about three-quarters of which is substituted with α-D-xylose-(1→6) at the 6-position. About one-third of the xylose residues are further substituted at the 2-position with β-D-galactose-(1→2). The presence of bulky side groups on the cellulosic backbone imparts water solubility to xyloglucan. Solution properties of xyloglucan are fairly stable against heat, pH, and mechanical agitation. Xyloglucan forms a gel only in the presence of alcohol or a substantial amount (ca. >40% by weight) of sugar.

Conflicting results have been reported for the molecular mechanism of interactions between gellan gum and xyloglucan. DSC profiles show trends similar to those for κ-carrageenan/glucomannan systems, which may invoke a similar molecular mechanism; that is, surface attachment of xyloglucan chains to local aggregates/crystalline regions of gellan gum. Circular dichroism (CD) studies have revealed abnormal temperature dependence of the ellipticity at temperatures slightly above the coil-helix transition temperature of gellan gum, indicating that intermolecular binding between gellan gum and xyloglucan may occur in this temperature range. However, both nuclear magnetic resonance (NMR) and atomic force microscopy (AFM) have failed to detect evidence for intermolecular binding between gellan gum and xyloglucan.

The reported CD data suggest that the molecular environment around the carboxyl group in disordered gellan gum molecules is not influenced by the presence of xyloglucan. (Nitta, Y. el al., Biomacromolecules, 4, 1654-1660, 2003). According to our rheological data, however, synergistic interactions between gellan gum and xyloglucan are evident even at high temperatures where gellan gum molecules are supposed to be in the disordered state. For example, mixed systems show remarkably larger values of the loss modulus than individual systems at temperatures above the setting temperature. It is thus unlikely that the synergy between gellan gum and xyloglucan originates from intermolecular binding between these two polysaccharides because it is unlikely that both ordered and disordered gellan gum molecules are sterically compatible with xyloglucan molecules.

The most likely mechanism is that the two polysaccharides exclude each other from the volume occupied by the self so that the effective concentration of each component becomes higher than the bulk concentration. Furthermore, the presence of xyloglucan molecules should hinder contacts between two gellan gum molecules, leading to the formation of finer networks of gellan gum with a reduced extent of lateral association between gellan gum molecules in the double-stranded helical conformation. A significant implication here is that gellan gum/xyloglucan blend gels are expected to exhibit reduced thermal hysteresis and syneresis due to reduced interhelical association. The validity of this molecular mechanism has been tested and confirmed by microscopic studies that have probed the presence of a number of free xyloglucan molecules in gellan gum/xyloglucan blend gels.

Consequently, the use of xyloglucan as a novel gelation agent for LA gellan gum yields two major advantages over conventional gelation agents such as salt and acid. First of all, xyloglucan prevents excessive association of LA gellan gum in the double-stranded helical conformation. As a result the melting temperature is only slightly higher than the setting temperature, thereby confining thermal hysteresis to within an acceptable level. The gel strength can be controlled without increasing thermal hysteresis over 5° C. by manipulating the total gum level as well as the mixing ratio of gellan gum and xyloglucan. Secondly, the presence of free xyloglucan molecules within a gellan gum network effectively reduces syneresis from gellan gum/xyloglucan blend gels because they bring a large number of hydrophilic groups and a boost in the osmotic pressure of the gel systems. One of skill in the art would know that the lack of cations and the use of a xylogucan lead to reduced syneresis in a gellan system.

The following examples are presented to illustrate the method of preparation and properties of LA gellan gum gels with reduced thermal hysteresis and syneresis. All percentages, concentrations, ratios, etc. are by weight unless otherwise noted. These examples are illustrative only and do not necessarily encompass the full breadth of the claimed invention.

### EXAMPLE 1

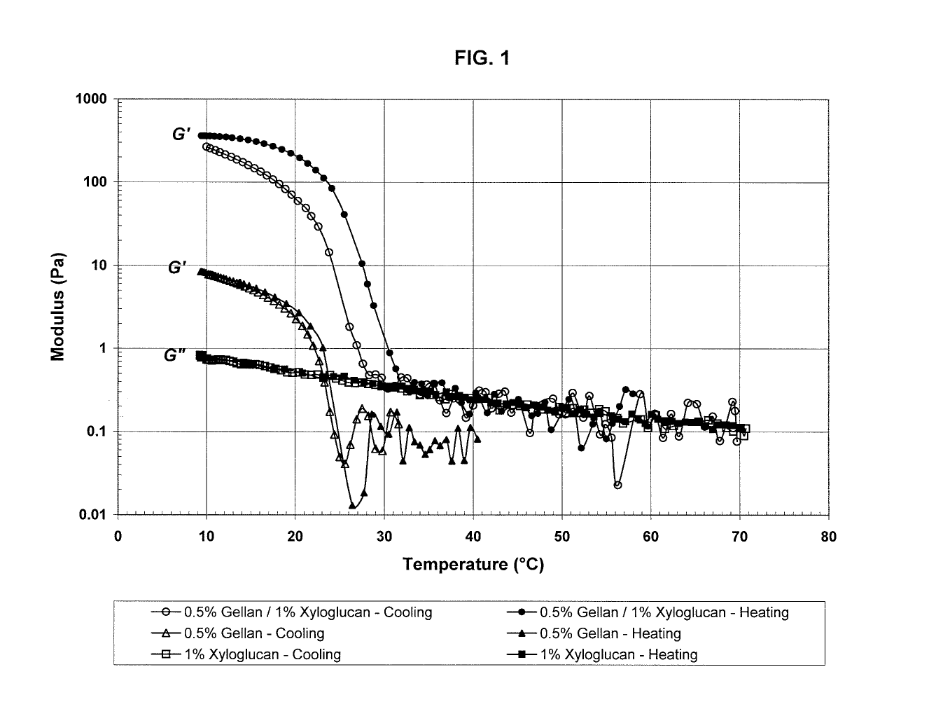

In FIG. 1, gel setting and melting profiles of an LA gellan gum/xyloglucan blend gels are compared with those of the individual polysaccharides. Table 1 gives compositions of the major residual cations in the gum samples. Weighed amounts of gums were dispersed into deionized water at room temperature and heated for 15 min in boiling water. The hot solution was loaded into a stress-controlled Bohlin rheometer, outfitted with a cone and plate fixture, preset at 70° C., and immediately covered with silicone oil to prevent water loss. The sample was cooled to 10° C. at a rate of 4° C./min, equilibrated at 10° C. for 120 s, and then heated >70° C. at a rate of 4° C./min. During the thermal treatments, the storage and loss modulus values were determined by applying a strain of 0.1.

TABLE 1
The composition of the major residual cations in gum samples.

| | Ca (%) | Na (%) | Mg (%) | K (%) |
|---|---|---|---|---|
| Gellan gum | 0.26 | 0.48 | 0.09 | 4.93 |
| Xyloglucan | 0.02 | 0.02 | 0.01 | 0.01 |

FIG. 1 demonstrates synergy between LA gellan gum and xyloglucan. Upon initial cooling of the mixture of 0.5% gellan gum and 1% xyloglucan, a rapid increase in the storage modulus value (G′), corresponding to the sol-to-gel transition, can be seen around 30° C. The storage modulus value reaches >350 Pa at 10° C., while the gel melts around 30° C. on the subsequent heating. Thermal hysteresis of this system is less than 5° C. Gellan gum itself shows much smaller storage modulus values below 10 Pa, confirming that xyloglucan is a highly effective gelation agent for LA gellan gum. Xyloglucan itself is a non-gelling polysaccharide. The solution of 1% xyloglucan shows no transitional change in the temperature dependence of the loss modulus in the temperature range between 10 and 70° C.

### EXAMPLE 2

As shown in Table 1, both LA gellan gum and xyloglucan samples contain relatively small amounts of cations. Therefore, effects of the addition of salt on gellan gum/xyloglucan interactions were investigated. Weighed amounts of gums were dispersed into aqueous solutions of NaCl at room temperature and heated for 15 min in boiling water. The hot solution was loaded into a cone and plate test fixture of a stress-controlled Bohlin rheometer preset at 70° C. and immediately covered with silicone oil to prevent water loss. The sample was cooled to 10° C. at a rate of 4° C./min, equilibrated at 10° C. for 120 s, and then heated >70° C. at a rate of 4° C./min. During the thermal treatments, the storage and loss modulus values were determined by applying a strain of 0.1. The setting temperature was defined as the temperature where the storage modulus value reached 1 Pa on cooling. The melting temperature was defined as the temperature where the storage modulus value reached 1 Pa on heating.

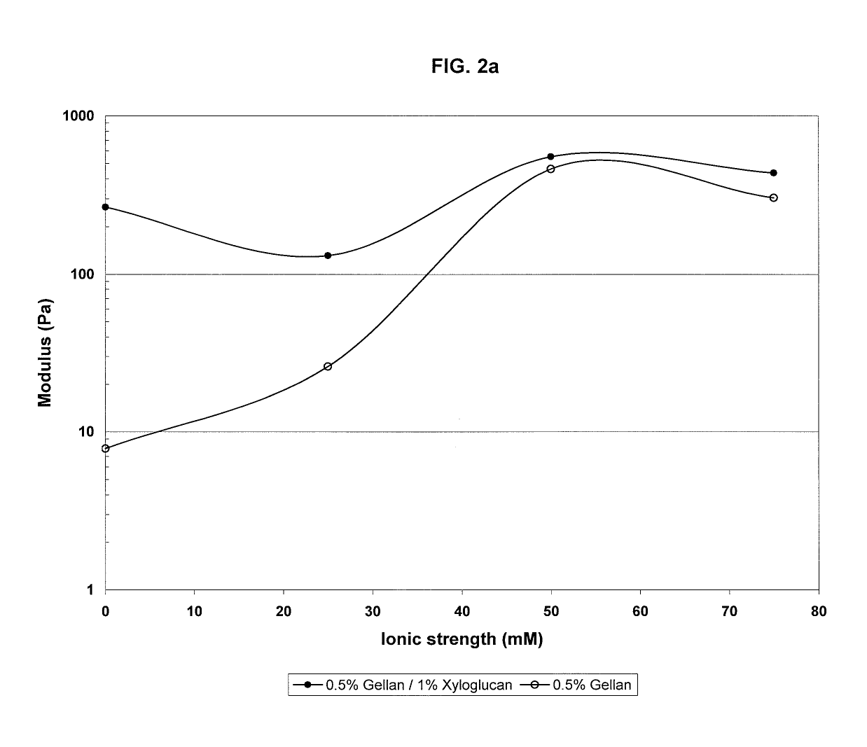

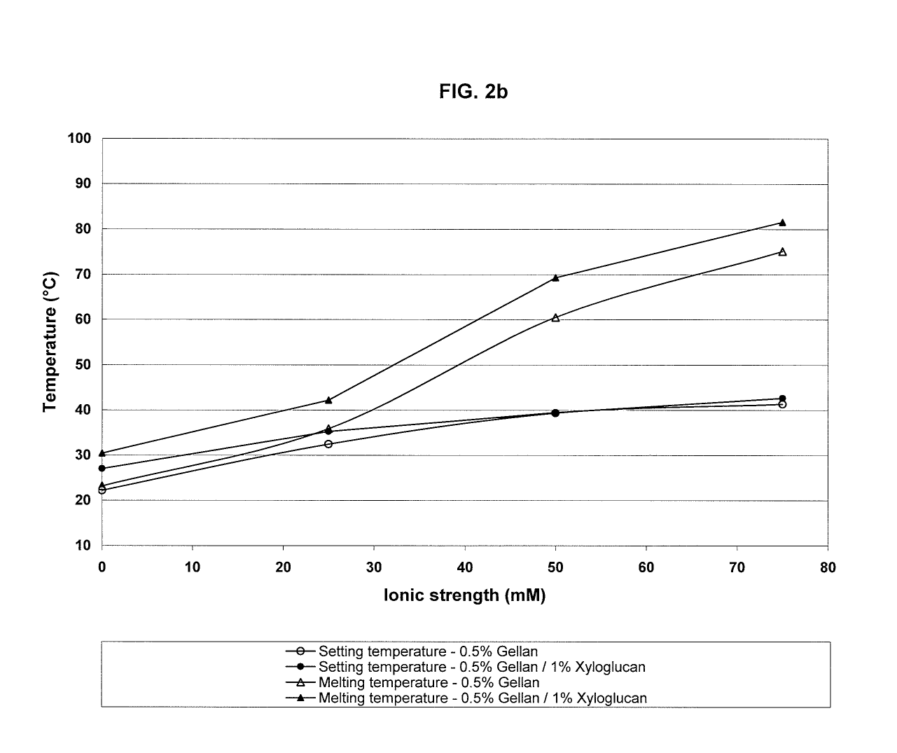

FIG. 2a shows effects of the ionic strength on storage modulus values determined at 10° C. Modulus values of gellan gum/xyloglucan blend gels are larger than those of unmixed gellan gum gels, while the increment in the modulus is most prominent in the absence of additional salt. The synergy between LA gellan gum and xyloglucan appears to be suppressed by the presence of high levels of sail equivalent to ionic strengths over 50 mM. FIG. 2b shows effects of the ionic strength on the setting and melting temperatures. The selling temperature is predominantly determined as a function of the ionic strength with little influence of xyloglucan. The melting temperature steeply increases with increasing ionic strength (approximately 7° C. per 10 mM), while the presence of xyloglucan contributes an additional 6-9° C. increase at all ionic strengths. These results suggest that xyloglucan has little effect on preventing interhelical association of gellan gum induced by the presence of relatively high levels of salt. This suggests that the ionic strength in the entire system should be lower than about 30 mM in order to utilize synergistic interactions between LA gellan gum and xyloglucan and limit thermal hysteresis to be narrower than about 5° C.

### EXAMPLE 3

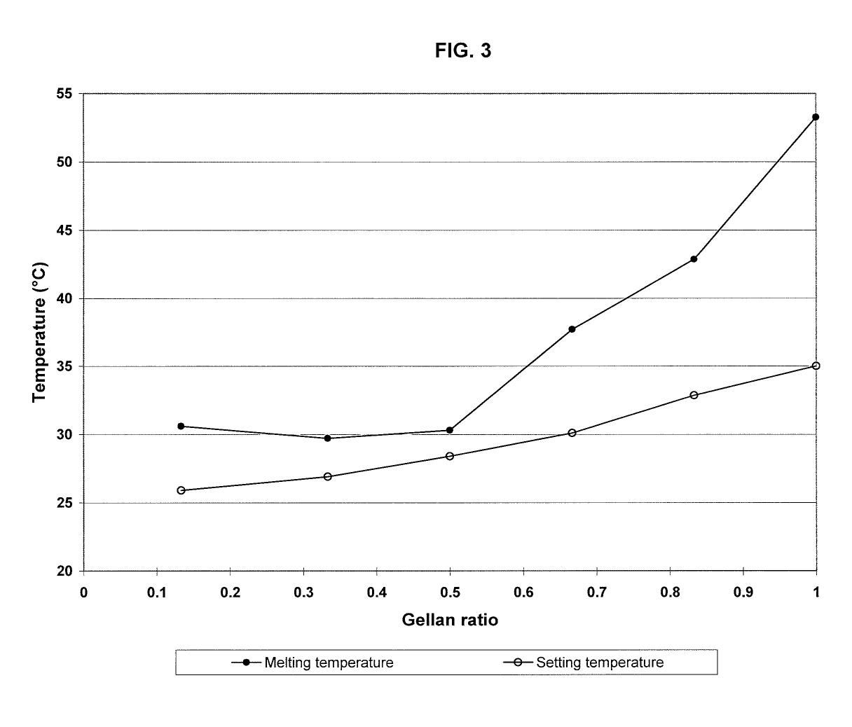

The significance of the mixing ratio of LA gellan gum and xyloglucan is illustrated in FIG. 3. The total gum content was fixed to be 1.5% and the mixing ratio of two gums was varied. Weighed amounts of gums were dispersed into deionized water at room temperature and healed for 15 min in boiling water. The hot solution was loaded into a cone and plate lest fixture of a stress-controlled Bohlin rheometer preset at 70° C. and immediately covered with silicone oil to prevent water loss. The sample was cooled to 10° C. at a rate of 4° C./min. equilibrated at 10° C. for 120 s, and then heated >70° C. at a rate of 4° C./min. During the thermal treatments, the storage and loss modulus values were determined by applying a strain of 0.1. The setting temperature was defined as the temperature where the storage modulus value reached 1 Pa during the cooling process. The melting temperature was defined as the temperature where the storage modulus value reached 1 Pa during heating.

In FIG. 3, the setting temperature gradually increases with increasing gellan gum content. This most likely reflects the relatively higher levels of residual ions in the gellan gum sample (See Table 1). The melting temperature is almost constant when the gellan gum ratio is less than 0.5. At a gellan gum ratio >0.5, the melting temperature increases steeply with increasing gellan gum ratio. These results show that the gellan gum content should be restricted to a certain level to prevent remarkable thermal hysteresis of >5° C. because of the relatively high levels of residual ions in the gellan gum sample.

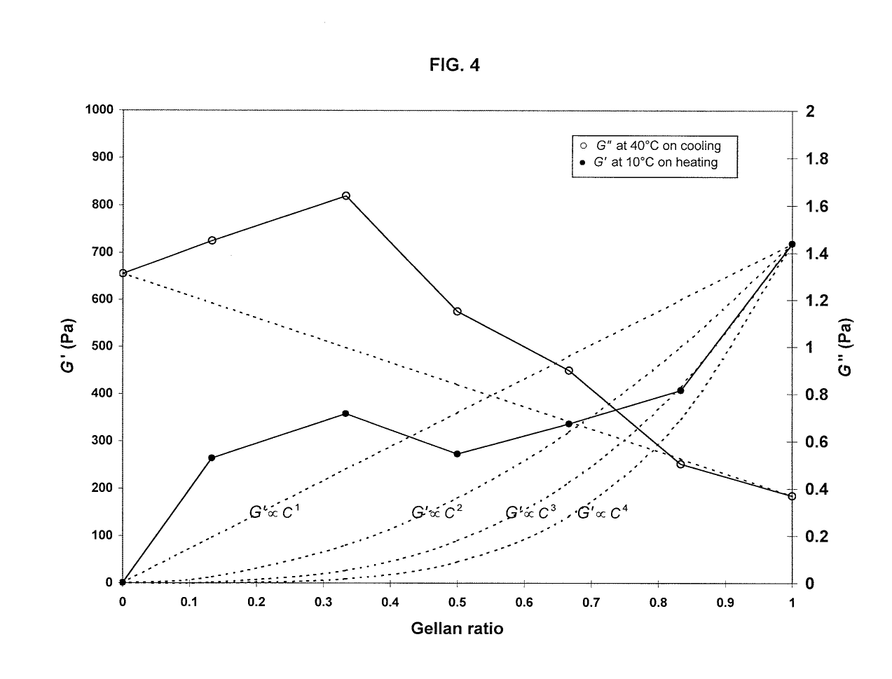

FIG. 4 shows relationships between the gellan gum ratio and dynamic modulus values. Storage modulus values determined at 10° C. are larger than the arithmetic means of values for individual systems (G′∝C¹) when the gellan gum ratio is less than a half. At a higher gellan gum ratio, storage modulus values are lower than the arithmetic means, but still larger than values expected based on a hypothetical power law relationship between the storage modulus and gellan gum concentration (G′∝C⁴). The cubic relationship between the gellan gum ratio and storage modulus indicates that synergistic effects of xyloglucan are progressively suppressed by increasing ionic concentration at higher gellan gum ratios. Loss modulus values determined at 40° C. on initial cooling are also plotted in FIG. 4. Most values are above the arithmetic means of values for individual systems, demonstrating synergy between gellan gum and xyloglucan occurring at this temperature, which is above the sol-gel transition temperature. These results show that both disordered and ordered gellan gum molecules synergistically interact with xyloglucan molecules. The optimal mixing ratio to maximize synergistic effects and minimize thermal hysteresis is achieved by a combination of 0.5% LA gellan gum and 1.0% xyloglucan at the total gum content of 1.5%.

### EXAMPLE 4

A soft capsule application, where gelatin is currently used, is one of the areas of interest for LA gellan gum/xyloglucan mixed systems. In this type of application, large modulus values at low temperatures as well as a low melting temperature are required because final capsule products are scaled by melting the periphery of two parts of a capsule with heat. Weighed amounts of gums were dispersed into an aqueous solution of 15% glycerol at room temperature and heated for 15 min in boiling water. The hot solution was loaded into a cone and plate test fixture of a stress-controlled Bohlin rheometer preset over 80° C. and immediately covered with silicone oil to prevent water loss. The sample was cooled to 10° C. at a rate of 4° C./min. equilibrated at 10° C. for 120 s, and then heated >90° C. at a rate of 4° C./min. During the thermal treatments, the storage and loss modulus values were determined by applying a strain of 0.1.

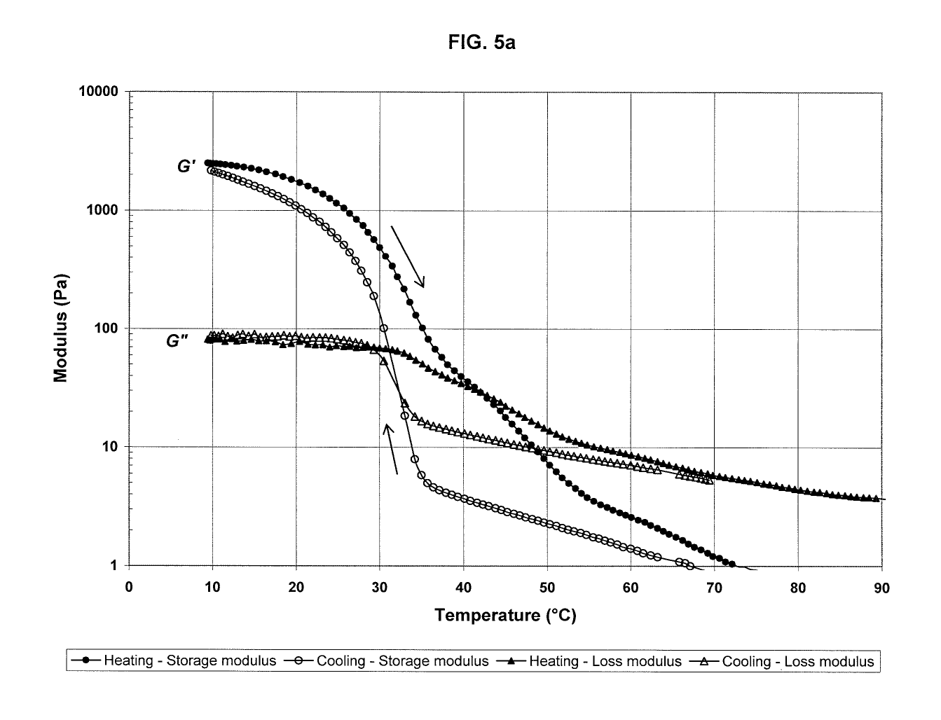

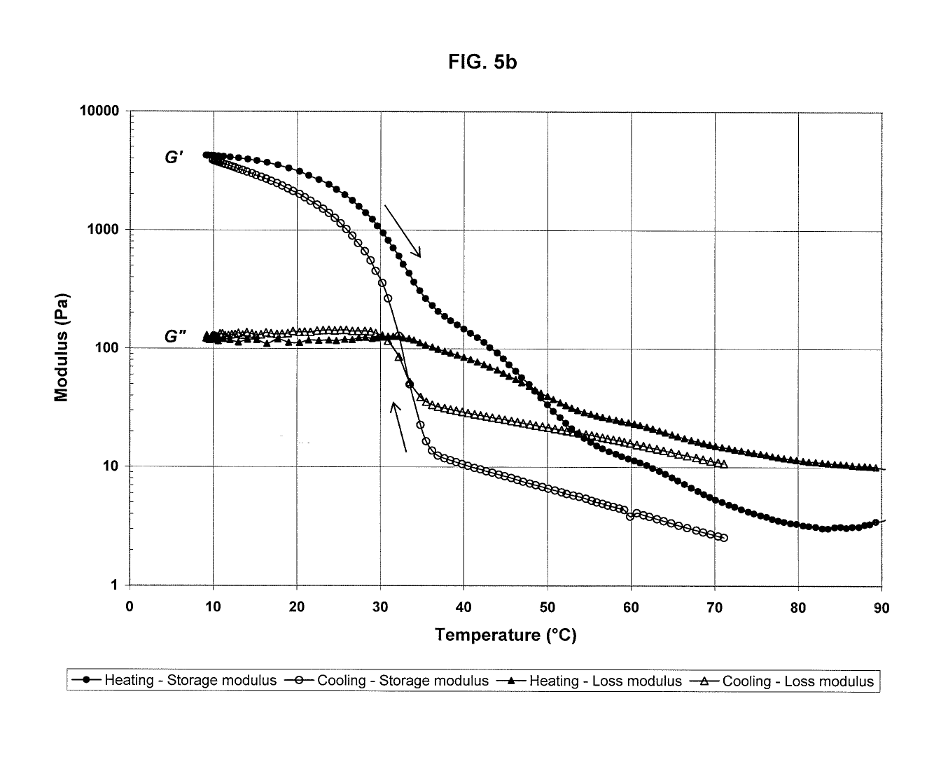

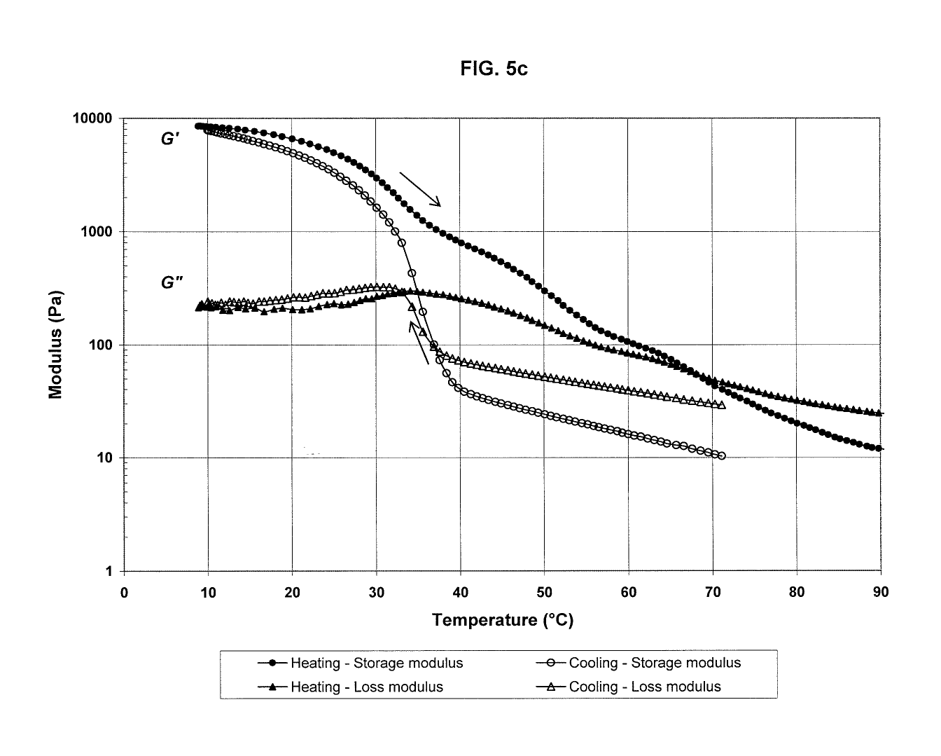

FIG. 5a shows that a mixture of 1% LA gellan gum and 1.5% xyloglucan forms a fairly strong gel with a storage modulus (G′) value around 2,500 Pa at 10° C. Furthermore, the melting temperature, defined as the temperature where the value of the loss modulus (G′) becomes greater than the value of storage modulus, remains low at 40° C. This melting temperature corresponds to thermal hysteresis of less than 10° C. and at the same time falls within a range where typical gelatin gels used for soft capsule application melt. Stronger gels are obtainable at higher gum levels, while the melt temperature also increases, presumably due to a proportional increase in the levels of counterions and other ions contained as impurities in the gums. FIG. 5b shows that a gel comprising 1.2% LA gellan gum and 1.8% xyloglucan gives a very large storage modulus value around 4,200 Pa at 10° C. However, the melting temperature and thermal hysteresis become about 48° C. and 15° C., respectively. FIG. 5c shows that a gel comprising 1.5% LA gellan gum and 2.25% xyloglucan has a very large storage modulus value around 8,500 Pa at 10° C. but the melting temperature and thermal hysteresis become about 67° C. and over 30° C., respectively.

1. A composition comprising low acyl gellan gum, xyloglucan, and water, wherein the composition exhibits reduced thermal hysteresis.

2. The composition according to claim 1, wherein the composition exhibits no measurable syneresis.

3. The composition according to claim 1 wherein the ionic strength is no more than about 30 mM.

4. The composition according to claim 2 having a thermal hysteresis of less than about 10° C. and no appreciable syneresis.

5. The composition according to claim 1 wherein the composition comprises from about 0.05% to about 1.5% gellan gum and from about 0.25% to about 2.5% xyloglucan.

6. The composition according to claim 4 wherein the composition comprises from about 0.1% to about 1.0%) gellan gum and from about 0.3% to about 1.5% xyloglucan.

7. The composition of according to claim 5 wherein the composition has a storage modulus value in the order of 100 Pa, a melting temperature of about 30° C., and thermal hysteresis of less than about 5° C.

8. The composition according to claim 3 wherein the composition comprises from about 0.5 to about 1.5% gellan gum and from about 1.0% to about 2.5% xyloglucan.

9. The composition according to claim 7 wherein the composition has a storage modulus value in the order of 1,000 Pa and a melting temperature of about 40° C.
